(19) United States
(12) Patent Application Publication
(10) Pub. No.: US 2014/0020500 A1
(43) Pub. Date: Jan. 23, 2014

(54) PARALLEL ROBOT WITH TWO DEGREES OF FREEDOM HAVING TWO KINEMATIC CHAINS WITH MAXIMIZED FLEXURE STIFFNESS

(71) Applicants: Sebastien Briot, Treillieres (FR); Stephane Caro, Nantes (FR); Coralie Germain, Sion Les Mines (FR)

(72) Inventors: Sebastien Briot, Treillieres (FR); Stephane Caro, Nantes (FR); Coralie Germain, Sion Les Mines (FR)

(73) Assignees: Ecole Centrale De Nantes, Nantes (FR); CNRS, Paris Cedex 16 (FR)

(21) Appl. No.: 13/989,002

(22) PCT Filed: Nov. 21, 2011
(86) PCT No.: PCT/EP2011/070598

§ 371 Date: Oct. 7, 2013

(30) Foreign Application Priority Data
Nov. 22, 2010 (FR) FR1004525

(51) Int. Cl. B25J 18/00

(52) U.S. Cl. CPC B25J 18/00; Y10S 901/15
USPC 74/490.05; 901/15

(57) ABSTRACT

A parallel robot is composed of two kinematic chains connecting a base to a platform having two degrees of freedom so that the platform is movable with respect to the base in a plane (x, z) of a space (x, y, z) in which the directions x, y and z are orthogonal to one another. The kinematic chains each having a bend connecting a proximal sub-chain, itself connected to the base, and a distal sub-chain, itself connected to the platform. The proximal sub-chain drives the bend in translation in the plane (x, z). The distal sub-chain of at least one of the two kinematic chains includes two rods separated from each other in the direction (y). The first and second ends of each rod are connected to the bend and the platform, respectively, by respective systems of connections composed of two pivots with axes orthogonal to each other.

### CROSS-REFERENCE TO RELATED APPLICATIONS

This application is a Section 371 National Stage Application of International Application No. PCT/EP2011/070598, filed Nov. 21, 2011, which is incorporated by reference in its entirety and published as WO 2012/069430 on May 31, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the invention is that of the design and manufacture of manipulating robots. More precisely, the invention concerns a parallel robot with two degrees of translation freedom, designed for applications involving the placing of components or objects at high rate, these applications commonly being designated by the term “pick and place”.

### BACKGROUND OF THE DISCLOSURE

In the field of the invention, the robots used for high-rate manipulation applications are not very numerous. The robots of this type can however be classified in two main categories:
serial robots, composed of a succession of rigid elements and motorised articulations, thus forming an open kinematic chain, the controlled member being connected to the base by a single kinematic chain;
parallel robots, composed of at least two kinematic chains, connecting the base to the controlled member, usually designated by the term “platform”, thus forming a closed architecture.

Each category can also be broken down into sub-categories according to the number of degrees of freedom of the robot.

In the category of serial robots, the most efficient make it possible to achieve accelerations of 8 G, for Adept cycle times (Δz=0.025 m, Δx=0.3 m) of 0.4 s, and a repeatability of around a hundredth of a millimetre. These robots have four degrees of freedom: 3 translations and 1 rotation of the controlled member.

In practice, it is found that these robots have limits in terms of acceleration; this is mainly due to their serial architecture. This is because the masses in movement are generally great since the elements of the serial robots carry, in addition to the load, the weight of the elements of the kinematic chain connecting the base and the controlled member. They are thus subjected to high flexure stresses and must be weighted and bulky in order to guarantee good overall stiffness for the robot. Their dynamic acceleration capabilities are therefore greatly degraded.

Conversely, parallel-architecture robots have the advantage of minimising the masses in movement, in particular when the motors are fixed to the base, which improves the dynamic performances.

Moreover, closed architectures intrinsically give rise to a greater stiffness of the kinematic chains used.

Industrial robots for applications of the pick and place type have therefore been developed on the basis of parallel architectures. Robots of this type have greater acceleration capabilities (ranging from 15 G to 25 G) than serial robots, with Adept cycle times that may lie between 0.25 s and 0.33 s.

Overall, even if the repeatability of the parallel robots used for pick and place applications, around 0.1 mm) is less good than that of serial robots used for the same tasks (around 0.008 mm), parallel robots clearly improve the cycle times as well as the productivity of a business, provided that precision is not a preponderant criterion.

Moreover, in order to limit the cost of the robots, due to a major extent to the motor and their controller, robots the controlled member of which has fewer degrees of freedom have recently been proposed.

These robots are useful in many tasks, such as operations of handling between two conveyors or assembly of components.

Since they have fewer degrees of freedom, they acquire fewer motors and are consequently less expensive. Among all robots with two degrees of freedom, the most widespread are those with two degrees of freedom in translation. Among these robots, two categories can be distinguished:
planar robots, where the movements of all their elements are coplanar;
spatial-architecture robots, where the movements of certain elements take place in non-parallel planes.

The robots most commonly used are planar robots. Among these, robots are known such as those illustrated by FIGS. 1 and 2, where the constant orientation of the platform is maintained by means of the use of flat parallelograms, which allow only translations between solids. They can be actuated either by rotary motors or in some cases by linear motors.

With regard in particular to the robot illustrated by FIG. 1, this achieves cycle times of 1.7 s, accelerations of 18 G and a repeatability of 0.5 mm. Its acceleration capabilities are limited because of the planar architecture, which has lower thickness since it is subject to flexure stresses in the direction normal to the plane of movement.

In order to solve this problem, it is possible to increase the mass of the moving elements. This is done however to the detriment of the acceleration capabilities and the cycle time.

Recently, a novel type of parallel robot with two degrees of translation freedom has been proposed. This robot, described by the patent document published under the number WO 2009/089916, has the particularity of having a spatial kinematic chain, that is to say, although the movements of the platform remain in one plane, the movements of some other elements constituting the kinematic chains may not take place in this plane. The robot is composed of four legs connecting the fixed base to the mobile platform, each leg consisting of an arm and a spatial parallelogram composed of two rods connected at their ends to the platform and to the arm by swivel connections.

The architecture of this robot is designed so that numerous bending stresses are eliminated, improving the stiffness of the robot and thus making it possible to reduce the moving masses. Such a robot achieves accelerations greater than 50 G and Adept cycle times of 0.25 s. However, with such a robot, low precision (greater than 1 mm) is to be regretted, due to several vectors, including which:
the architecture of the robot is complex (with its four legs), tending to increase the difficulty of identification of the model used for controlling the robot, which may therefore prove to be imprecise and consequently impair the final precision of the robot;
it uses a belt for coupling the arms, which reduces the stiffness of the robot;
it is difficult to calibrate and consequently leads to errors in positioning the platform;
the swivel connections constrained by springs used in the spatial parallelograms for limiting the plays in the connections give rise to high friction that is difficult to identify in the control models, which may therefore prove to be imprecise and consequently impair the final precision of the robot; moreover, the friction in these connections causes high wear and consequently frequent and expensive maintenance.

### SUMMARY

An exemplary aspect of the present disclosure relates to a parallel robot composed of two kinematic chains connecting a base to a platform intended to be moved with respect to the base, of the type having only two degrees of freedom so that the platform is able to be moved with respect to the base in a plane (x, z) of a space (x, y, z) in which the directions x, y and z are orthogonal to one another, the kinematic chains each having a bend connecting a proximal sub-chain, itself connected to the base, and a distal sub-chain, itself connected to the platform, said proximal sub-chain being intended to drive the bend in translation in the plane (x, z). According to the invention, the distal sub-chain of at least one of the two kinematic chains comprises two rods separated from each other in the direction (y), a first end of each rod being connected to said bend by a system of connections composed of two pivots with axes orthogonal to each other, the axes of the two pivots of the system of connections of one of the rods each forming a non-zero angle with the axes of the two pivots of the system of connections of the other rod, the second end of each rod being connected to said platform by a system of connections also composed of two pivots with axes orthogonal to each other, the axes of the two pivots of the system of connections of one of the rods each forming a non-zero angle with the axes of the two pivots of the system of connections of the other rod.

Thus, by virtue of the invention, a robot is obtained with an optimised design with regard in particular to:
improving its stiffness and therefore its acceleration and production rate capabilities and/or its precision;
reducing the complexity of its architecture, facilitating the control of its various components in order to obtain better final precision and/or to reduce the maintenance operations related to wear.

This is because the connection systems connecting the rods of the distal sub-chain on the one hand to the bend and on the other hand to the platform make it possible to make the rods of the distal sub-chain work only in compression and/or torsion. As a result all the bending stresses are transferred to the proximal sub-chain, which constitutes an element where the robot designers conventionally manage to adapt the characteristics in order to withstand bending stresses without this appreciably varying the precision and/or production rate of the robot.

In other words, compared with flat architectures with two degrees of freedom in which all the elements are subjected to flexure stresses in the direction orthogonal to the plane of movement, a robot according to the invention comprises far fewer elements subject to the flexure stresses. Thus it is intrinsically stiffer than the existing planar robots. This makes it possible to reduce the mass of the elements in movement and improve the acceleration capabilities and/or its precision.

It has been shown that, with a robot according to the invention, for equivalent stiffness, the architecture according to the invention is less than half the weight of a robot as illustrated by FIG. 1.

In addition, in comparison with the robot described by the patent document WO 2009/089916, which is composed of four legs limiting the movement of the controlled member and adding inertia, a robot according to the invention has a larger working space and fewer masses in movement. For equivalent stiffness, the architecture of a robot according to the invention is approximately one and a half times lighter than the robot described by the document WO 2009/089916.

In summary, improving the stiffness and reducing the moving masses of a robot according to the invention leads to an improvement in its acceleration capacities and an improvement in its precision compared with the robot of the prior art. In addition, the working space (the area swept by the mobile platform in cartesian space) is greater with a robot according to the invention.

In addition, the architecture of a robot according to the invention uses only two kinematic chains and does not use swivel connections. On the contrary, all these connections can be implemented by means of bearings, which are by default well suited to high-speed movements in mechanisms. These advantages result in a reduction in maintenance operations and ease in control of the robot with a view to obtaining very good precision.

According to a preferred embodiment, the two pivots connecting said rod to the bends are grouped together within a cardan drive, in the case of at least one of the rods.

According to another preferred aspect, the two pivots connecting said rod to the platform are grouped together in a cardan drive in the case of at least one of the rods.

The use of one or other or both of these features makes it possible to obtain a robot with greater compactness.

In addition, for the same rod, the axes of the two pivots at one of the ends of the rod are parallel to the axes of the pivots at the other end of the rod.

According to an advantageous solution, the proximal sub-chain comprises two parallel sides defining a parallelogram with the base and bend.

In this case, each side is advantageously connected to the base by a pivot.

Preferentially, each kinematic chain is connected to the base by at least one motorised pivot.

In addition, each side is advantageously connected to the bend also by a pivot.

In this case, the pivots that connect the two sides to the base and to the bend are all parallel to each other.

According to one variant that can be envisaged, at least one of the two sides comprises two parallel linkages.

According to another embodiment, the proximal sub-chain comprises a set of three linkages connecting the base to the bend, a first of which is connected at each of its ends by two pivots and the other two of which are each connected firstly to the base by a system of connections composed of two pivots with axes orthogonal to each other and secondly to the bend also by a system of connections composed of two pivots with axes orthogonal to each other.

According to yet another embodiment that can be envisaged, the proximal sub-chain comprises two segments connected together by a prismatic connection, one of the segments being connected to the base and the other segment being connected to the platform.

### BRIEF DESCRIPTION OF THE DRAWINGS

Other features and advantages will emerge more clearly from a reading of the following description of five preferential embodiments of the invention, given by way of simple illustrative and non-limitative examples, and the accompanying drawings, among which:

FIGS. 1 and 2 are robots of the prior art;

FIG. 3 is a schematic view in perspective of a robot according to a first embodiment of the invention;

FIGS. 4 and 5 are diagrams illustrating the numbering rules for the directions xₖⱼᵢ, yₖⱼᵢ and zₖⱼᵢ;

FIG. 6 is a partial kinematic representation of the robot illustrated by FIG. 3;

FIG. 7 is a partial kinematic representation of a robot according to a second embodiment of the invention;

FIG. 8 is a partial kinematic representation of a robot according to a third embodiment of the invention;

FIG. 9 is a partial kinematic representation of a robot according to a fourth embodiment of the invention;

FIG. 10 is a partial kinematic representation of a robot according to a fifth embodiment of the invention.

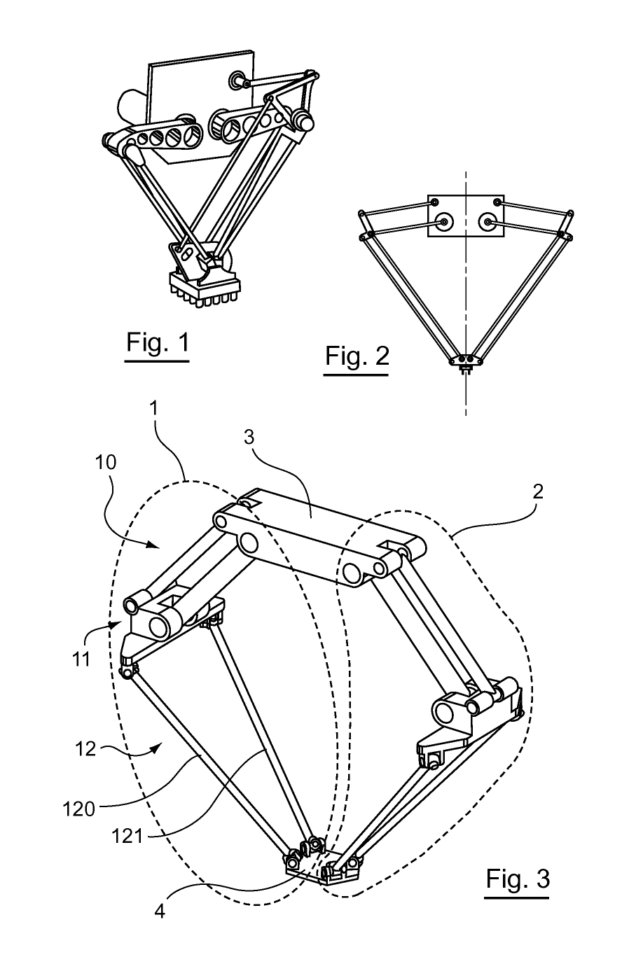

### DETAILED DESCRIPTION OF ILLUSTRATIVE EMBODIMENTS

With reference to FIG. 3, a parallel robot according to the invention comprises two kinematic chains 1, 2, each connecting the base 3 to the platform 4 (constituting the controlled movable member), intended to be moved with respect to the base (constituting the fixed member).

Such a robot has only two degrees of freedom in translation so that the platform 4 can be moved with respect to the base in a plane x₀, z₀ in a space (x₀, y₀, z₀) in which the directions x₀, y₀ and z₀ are orthogonal to one another and define a three-dimensional space.

Each kinematic chain (the two chains being identical) comprises:
a proximal sub-chain 10;
a bend 11;
a distal sub-chain 12.

The bend 11 connects, by means of a system of connections described in more detail hereinafter, the proximal sub-chain and the distal sub-chain.

The proximal sub-chain is therefore connected by one of its ends to the bend 11 and by the other of its ends to the base 3, here by means of connections of the pivot type.

The distal sub-chain is for its part connected first to the bend 11 and secondly to the platform by a system of connections also described in more detail hereinafter.

According to the principle of the invention, the distal sub-chain of the two kinematic chains of the robot comprises two rods 120, 121 separated from each other in the direction y.

As is clear in FIG. 3, the rods 120, 121 are not parallel to each other and extend symmetrically with respect to a median axis connecting the bend 11 and the platform 4 between the bottom and top ends of the rods 120, 121.

In addition, the articulations between the rods of the distal sub-chain and the bend on the one hand and the platform on the other hand are designed so that:
the end of the top bar 120 is connected to the bend 11 by a connection system composed of two pivots with axes parallel to each other;
the top end of the rod 121 is connected to the bend 11 by a connection system composed of two pivots with axes orthogonal to each other;
the bottom end of the rod 120 is connected to the platform 4 by a connection system also composed of two pivots with axes orthogonal to each other;
the bottom end of the rod 121 is connected to the platform 4 by a connection system also composed of two pivots with axes orthogonal to each other.

In addition, the axes of the two pivots of the connection system connecting the top end of the bar 120 with the bend 11 each form a non-zero angle with the axes of the two pivots of the connection system connecting the top end of the bar 121 with the elbow 11.

The same applies to the connection systems of the bottom ends of the bars 120, 121. More precisely, the axes of the two pivots of the connection system connecting the bottom end of the bar 120 with the platform 4 each form a non-zero angle with the axes of the two pivots of the connection system connecting the bottom end of the rod 121 with the platform.

It should be noted that, for the same rod, the axes of the two pivots of the connection system at one of the ends of the rod are parallel to the axes of the two pivots of the connection system at the other end of the rod.

These aspects are illustrated by FIG. 6, which shows kinematically one of the kinematic chains of a robot according to a first embodiment of the invention.

First the following notation rules relating to the directions yₖⱼᵢ and zₖⱼᵢ should be noted.

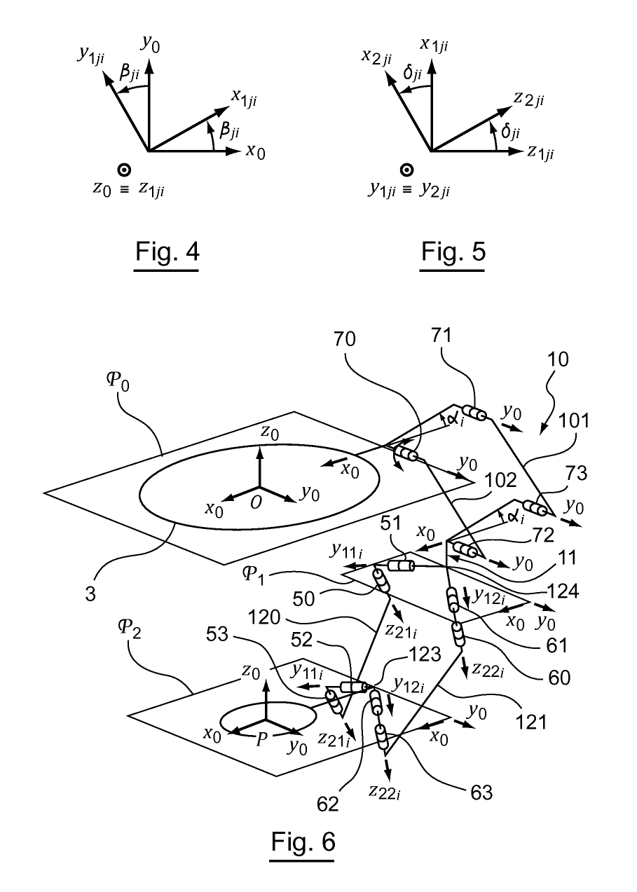

According to this numbering, the index i corresponds to the number of the kinematic chain (i=1 or 2 depending on the chain that is being studied). Next, in the notation yₖⱼᵢ or zₖⱼᵢ, the index j (j=1 or 2) corresponds to one of the sub-assemblies of the distal sub-chain. The sub-assembly j=1 is composed, in FIG. 6, of the elements 50, 51, 120, 52 and 53 and the sub-chain j=2 is composed of the elements 60, 61, 121, 62 and 63. As for the index k (k=1 or 2), this defines the number of reference-frame transformation or transformations necessary for passing from (x₀, y₀, z₀) to (xₖⱼᵢ, yₖⱼᵢ, zₖⱼᵢ) (FIGS. 4 and 5). That is to say, in order to pass from the vector y₀ to y₁ⱼᵢ, a rotation is made about the vector y₀ (FIG. 4), and therefore k=1. To pass from the vector z₀ to z₂ⱼᵢ, two rotations are made (and therefore k=2), one around the vector z₀ (FIG. 4) and another around y₁ⱼᵢ (FIG. 5).

As illustrated by FIG. 6, the distal sub-chain is designed as follows:
the rod 120 is connected to the bend 11 by a set of two pivots 50, 51, the pivot 51 having a pivot axis y₁₁ᵢ and the pivot 50 having a pivot axis z₂₁ᵢ orthogonal to the pivot axis y₁₁ᵢ;
the rod 120 is connected to the platform 4 by two pivots 52, 53, the pivot 52 having a pivot axis y₁₁ᵢ (and therefore parallel to that of the pivot axis of the pivot 51) and the pivot 53 having a pivot axis z₂₁ᵢ (and therefore parallel to the pivot axis of the pivot 50) orthogonal to the pivot axis y₁₁ᵢ;
the rod 121 is connected to the bend 11 by two pivots 60, 61, the pivot 61 having a pivot axis y₁₂ᵢ and the pivot 60 having a pivot axis z₂₂ᵢ orthogonal to the pivot axis y₁₂ᵢ;
the rod 121 is connected to the platform 4 by two pivots 62, 63, the pivot 62 having a pivot axis y₁₂ᵢ (and therefore parallel to the axis of the pivot 61) and the pivot 63 having a pivot axis z₂₂ᵢ (and therefore parallel to the pivot axis 60).

According to the principle of the invention, the pivot axes y₁₁ᵢ and y₁₂ᵢ respectively of the pivots 51 and 61 are neither parallel nor merged. The same applies to the pivot axes y₁₁ᵢ and y₁₂ᵢ respectively of the pivots 52 and 62.

Moreover, according to an embodiment illustrated by FIG. 6, the proximal sub-chain 10 is formed by two parallel sides 101, 102, defining a parallelogram with the base 3 and with the bend 11.

The top ends of the bars 101, 102 are connected to the base 3 each by a pivot connection 70, 71. The pivots 70, 71 have pivot axes parallel to each other, in the direction y₀ of the reference frame x₀, y₀, z₀ associated with the base 3.

The bottom ends of the rods 101, 102 are connected to the bend 11 each by a pivot 72, 73. The pivots 72, 73 have pivot axes parallel to each other extending in the direction y₀.

In this configuration, the axes of the pivots 70, 71 are therefore parallel to each other and parallel to the pivot axes of the pivots 72, 73.

It should be noted that, in the embodiment illustrated by FIG. 6, as well as in the embodiments described hereinafter, the robot also has the following features:
the rods 120, 121 are non-parallel and extend symmetrically on either side of a median axis connecting the points 123, 124 (the point 123 being the point centred between the bottom ends of the rods 120, 121 at the platform 4 and the point 124 being the point centred between the top ends of the bars 120, 121 at the bend 11);
the base 3 lies in a plane P₀ defined by the direction x₀, y₀ of a reference frame x₀, z₀ associated with the base, the platform 4 lying in a plane P₂ parallel to the plane P₀;
the bend 11 lies in a plane P₁, parallel to the plane P₀, in which the directions y₁₁ᵢ and y₁₂ᵢ lie.

In addition, in the embodiment illustrated by FIG. 6, one of the pivots 70, 71 connecting respectively the rods 101, 102 to the base 3 is actuated by a motor fixed to the base 3.

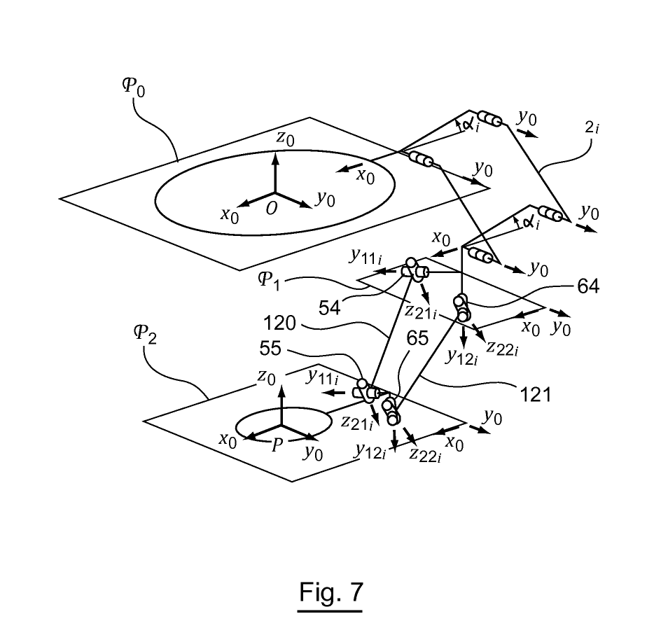

FIG. 7 illustrates a second embodiment of the invention.

The difference from the previous embodiment lies in the fact that:
the pivots 50, 51 of the connection system connecting the bar 120 to the bend 11 are grouped together in a cardan drive 54 the pivot axes of which are orthogonal and repeat the directions y₁₁ᵢ and z₂₁ᵢ of the pivots 50, 51;
the pivots 52, 53 of the connection system connecting the leg 120 to the platform 4 are grouped together in a cardan drive 55 the orthogonal axes of which repeat the directions y₁₁ᵢ and y₂₁ᵢ of the pivots 52, 53;
the pivots 60, 61 of the connection system connecting the rod 121 to the bend 11 are grouped together in a cardan drive 64 the orthogonal axes of which repeat the direction y₁₂ᵢ and z₂₂ᵢ of the pivots 61, 60;
the pivots 62, 63 of the connection system connecting the rod 121 to the platform 4 are grouped together in a cardan drive 65 the orthogonal axes of which repeat the directions y₁₂ᵢ and z₂₂ᵢ of the pivots 62, 63.

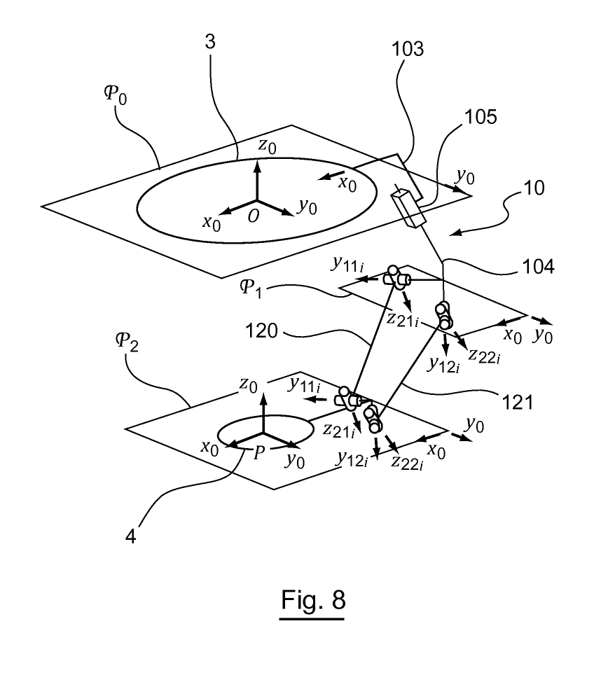

FIG. 8 illustrates in kinematic form a variant of the kinematic chain illustrated by FIG. 7.

According to the variant illustrated by FIG. 8, the connection systems connecting the rods 120, 121 to the bend 11 and to the platform 4 are kept.

On the other hand, the parallelogram of the proximal sub-chain 10 is replaced by two segments 103, 104 connected together by a prismatic connection 105, the segment 103 being connected to the base 3 and the segment 104 being connected to the bend 11.

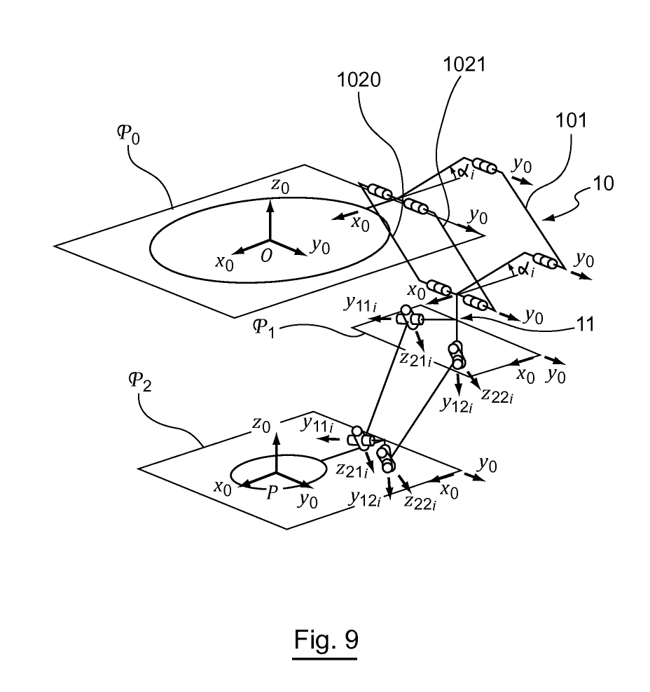

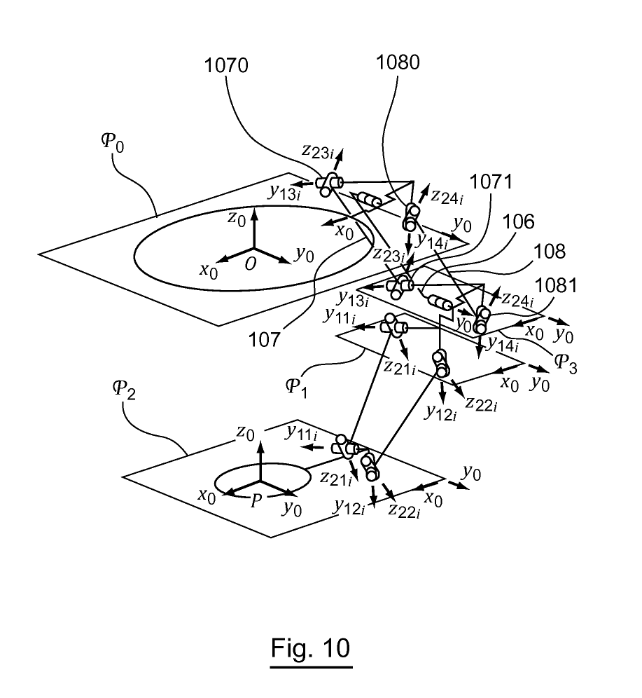

In the variants illustrated by FIGS. 9 and 10, the proximal sub-chain has been modified in order to improve its flexural stiffness without however changing the movement of the bend (translation with respect to the base).

According to the embodiment illustrated by FIG. 9, one of the subassemblies of the parallelogram formed by the proximal sub-chain 10 has been duplicated in order to improve its flexural stiffness.

The proximal sub-chain 10 therefore consists of two subassemblies forming two parallelograms, namely:
a first subassembly formed by a linkage 101;
a second subassembly formed by two linkages 1020 and 1021 parallel to each other.

These two subassemblies therefore define a parallelogram with the base 3 and the bend 11. It should be noted that the first subassembly could also consist of two linkages parallel to each other according to yet another variant that can be envisaged.

In the embodiment illustrated by FIG. 10, the parallelogram of the proximal sub-chain is dispensed with and replaced by a set of three rods.

Rod number 106 is the actuated rod of the system and therefore the one that is connected to the motor placed on the base. It is connected to the bend by a pivot of axis y₀. The base is also connected to the bend by the rods 107, 108 by means of cardan connections (or orthogonal pivots), respectively 1070 and 1080 fixed at their ends. The axes of the two cardan drives 1070, 1071 of the rod 107 are parallel to each other. The axes y₁₃ and y₁₄ must not be parallel to each other. This type of system allows a circular translation of the bend. However, its main advantage is as follows: the rods 107 and 108, by virtue of the particular arrangement of the cardan connections, are acted on only under traction/compression/torsion. Thus the stiffness of the proximal part is considerably increased by virtue of this system. It should however be noted that the rod 106 is always stressed under flexion, this stressing being minimised by virtue of the use of the mechanism composed of the rods 107 and 108.

An exemplary embodiment of the invention proposes a parallel robot with two degrees of freedom in translation with a maximised flexure stiffness that improves the acceleration capabilities and therefore the production rates of the robot and/or obtains better final precision.

An exemplary embodiment reduces the complexity of the architecture in comparison with some robots of the prior art.

An exemplary embodiment provides such a robot that limits the maintenance operations.

Although the present disclosure has been described with reference to one or more examples, workers skilled in the art will recognize that changes may be made in form and detail without departing from the scope of the disclosure and/or the appended claims.

1. A parallel robot comprising:
two identical kinematic chains connecting a base to a platform, which has only two degrees of freedom so that the platform is able to be moved with respect to the base in a plane (x, z) of a space (x, y, z) in which the directions x, y and z are orthogonal to one another, the kinematic chains each having a bend connecting a proximal sub-chain, itself connected to the base, and a distal sub-chain, itself connected to the platform, wherein:
said proximal sub-chain being configured to drive the bend in translation in the plane (x, z),
the distal sub-chain of at least one of the two kinematic chains comprises two rods separated from each other in the direction (y), a first end of each rod being connected to said bend by a system of connections composed of two pivots with axes orthogonal to each other, the axes of the two pivots of the system of connections of one of the rods each forming a non-zero angle with the axes of the two pivots of the system of connections of the other rod, the second end of each rod being connected to said platform by a system of connections also composed of two pivots with axes orthogonal to each other, the axes of the two pivots of the system of connections of one of the rods each forming a non-zero angle with the axes of the two pivots of the system of connections of the other rod, and
the proximal sub-chain is formed by two parallel sides defining a parallelogram with the base and the bend, each side being connected to the base by a pivot.

2. The parallel robot according to claim 1, wherein, for at least one of the rods, the two pivots connecting said rod to the bend are grouped together in a cardan drive.

3. The parallel robot according to claim 1, wherein, for at least one of the rods, the two pivots connecting said rod to the platform are grouped together in a cardan drive.

4. The parallel robot according to claim 1, wherein each kinematic chain is connected to the base by at least one motorised pivot.

5. The parallel robot according to claim 4, wherein each side is connected to the bend by a pivot.

6. The parallel robot according to claim 4, wherein the axes of the pivots connecting the two sides to the base and to the platform are all parallel to each other.

7. The parallel robot according to claim 1, wherein at least one of the sides comprises two parallel linkages.

8. The parallel robot according to claim 1, wherein the proximal sub-chain comprises a set of three linkages connecting the base to the bend, a first one of which is connected at each of its ends by two pivots and the other two of which are each connected firstly to the base by a system of connections composed of two pivots with axes orthogonal to each other and secondly to the bend also by a system of connections composed of two pivots with axes orthogonal to each other.

9. The parallel robot according to claim 1, wherein the proximal sub-chain comprises two segments connected together by a prismatic connection, one of the segments being connected to the base and the other segment being connected to the bend.
